(19) United States
(12) Patent Application Publication
(10) Pub. No.: US 2003/0155510 A1
(43) Pub. Date: Aug. 21, 2003

(54) Optical mapping apparatus

(76) Inventors: Andrew Dean, Royston (GB); Alan H Lettington, Whiteknights (GB); David A Huckridge, Malvern (GB)

Correspondence Address: NIXON & VANDERHYE, PC, 1100 N GLEBE ROAD, 8TH FLOOR, ARLINGTON, VA, 22201-4714, US

(21) Appl. No.: 10/312,846

(22) PCT Filed: Jun. 29, 2001
(86) PCT No.: PCT/GB01/02864

(30) Foreign Application Priority Data
Jul. 1, 2000 (GB) 0016081.2

(51) Int. Cl. G01J 5/02

(52) U.S. Cl. 250/332; 250/353

(57) ABSTRACT

Optical mapping apparatus in which a long, one or two dimensional detector array or higher resolution two dimensional array is synthesised using a two dimensional array (of shorter dimensions). The two dimensional array has an input mask having waveguides with a smaller input than output and the apparatus is adapted to scan the scene relative to the array to image different parts of the scene. In one embodiment the apparatus is adapted such that different parts of a line through the image which is perpendicular to the scan direction are imaged at different times as the detector array is scanned.

The invention relates to apparatus for use in an imaging system which enables a detector array to simulate a different array of different resolution, in particular to an apparatus allowing a long linear detector array to be simulated using a shorter two dimensional detector array. The invention is of particular use for thermal imaging arrays.

Conventionally, infrared detectors are based on focal plane detector arrays comprising a small number of detector elements. In order to produce a suitable image of a scene, the infrared detector must therefore be scanned across the scene in two dimensions. To be compatible with TV display equipment, high speed scanning is required and therefore detector integration times at any point of the scene are short. This limits the thermal sensitivity which can be achieved by the system.

This problem can be overcome by using focal plane arrays having long linear or two dimensional array formats. The availability of such detector formats enables thermal imaging detectors to be built with simple one dimensional scanning (if long linear arrays are used) or with no scanning at all (if two dimensional arrays are used). This improves thermal sensitivity since longer integration times can be employed.

However, the manufacture of long linear arrays is difficult and costly. A number of possible approaches to develop longer arrays including direct fabrication or techniques such as “butting” or “stagger butting” shorter arrays are known in the literature: e.g. (Short-wave Infrared 512×2 Line Sensor for Earth Resources Applications, John R Tower et al, p1574 IEEE Transactions on Electron Devices, Vol Ed-32, No8, 1985) However, these approaches are technically difficult and pose additional systems problems. In particular, providing an efficient means of cold shielding such arrays is problematic.

In addition, linear arrays of excessive length are impractical. Typically, commercially available infrared detectors have square detector elements, and the dimensions of a single element may be around 30 μm by 30 μm with a centre-to-centre spacing of ≧30 μm. Two dimensional arrays of 256×256 elements, and even 512×512 elements, are mass produced. However, an array of 1024 elements of 30 μm size elements is about 31 mm in length, a 2048 element array would be about 62 mm in length and a 4096 element array around 123 mm long. Therefore, at present, the size of infrared focal plane arrays having in excess of 1024, 30 μm square elements is impractical. Arrays having smaller sized elements, around 20 μm, can be used to provide slightly more practical focal plane arrays. However, such arrays are more difficult to manufacture.

There exists a requirement for an apparatus which has the capability of a long, linear array of infrared detector elements but which is of a size which is suitable for practical applications. Furthermore, the problems of fabricating such long, linear detector arrays, cooling and efficiently cold shielding them also needs to be overcome.

U.S. Pat. No. 4,204,230 relates to a method for simulating a long linear array in the visible regime using a laterally staggered two dimensional array. The array is scanned in a cross scan direction relative to the subject and the outputs from the staggered photosensitive zones used to simulate a linear array. The apparatus described in this patent however uses a sparse detector array, i.e. one having a large pitch between detector areas. Most modern thermal imaging devices use high density arrays.

It is an object of the present invention to provide an apparatus which mitigates these problems.

According to the present invention there is provided an imaging apparatus comprising a two dimensional detector array of detector elements and an input having a waveguide associated with each detector element, each waveguide having an input for receiving radiation for a scene and an output for passing radiation to its associated detector element characterised in that the output of each waveguide is larger than the input and wherein the apparatus comprises means for scanning the scene relative to the array so as to allow synthesis of a different sized array.

Having a waveguide wherein the output is larger than the input allows the array to be scanned relative to a scene so that each waveguide input receives radiation from a different part of the scene, ensuring the resolution is as high as possible. However the large waveguide output allows all the detector element to receive radiation and hence minimises any unnecessary losses. This is especially the case where high density arrays are used. In high density arrays the pitch, i.e. the distance between detector elements, is low compared to the detector element size. Thus without a suitable input mask scanning of the array would cause unnecessary overlap of the scene on neighbouring detector elements with consequent oversampling. By an appropriate choice of size of waveguide input overlap can be avoided and the resolution of the synthesised array increased.

To maximise the efficiency of the array the waveguide ouputs are preferably adapted such that substantially all the detector element area receives radiation from the scene. Conveniently the input mask comprises a plate and each waveguide comprises a tapered aperture therethrough.

Preferably the imaging apparatus comprises a first optical system for passing radiation from the scene to the input mask. Advantageously the first optical system is adapted to increase the energy density of radiation at the input mask. Conveniently the first optical system increases the energy density of the radiation from a scene by a factor related to the ratio of the size of the input and output of the waveguides.

Use of an input mask reduces the amount of radiation reaching the detector array and so reduces the efficiency of the array as compared to use without the mask. However by using an optical system to increase the energy density of the radiation at the input mask the efficiency can be increased. Due to having the mask, the amount of radiation reaching the detector array is reduced, compared with operation without a mask, by a factor related to the ratio of the area of the input of the waveguide to the area of the detector element (which is preferably the same as the area of the waveguide output). If the first optical system increases the overall energy density by the same factor as the input mask decreases the energy density there is no overall loss associated with use of an input mask. Other arrangements for the first optical system could be used depending on system requirements.

Conveniently the first optical system comprises a series of lenses. The person skilled in the art would be aware of lens systems that could be used for the optical system.

Alternatively the first optical system could comprise means for focussing input radiation substantially onto the inputs of the waveguides. By ensuring that the radiation is focussed on the waveguide inputs no loss of signal will result due to radiation falling between waveguide inputs. Conveniently the first optical system comprise an arrangement of lenses.

Conveniently the input mask is located adjacent the detector array. This allows for ease of manufacture and set up. Alternatively the apparatus could comprise a relay optical system located between the input mask and the detector array for passing radiation from the mask to the array. The relay optical system could be arranged to increase the energy density of radiation on the detector array. The relay optical system could be used in conjunction or instead of the first optical system.

In one embodiment the apparatus is scanned relative to a scene in a scan direction and the input mask and detector elements are arranged such that radiation from different parts of an image line perpendicular to the scan direction is imaged at different times as the apparatus is scanned in the scan direction.

By image line is meant any line through a scene to be imaged across which the scanning apparatus is scanned.

Effectively therefore only part of an image line is ever imaged at one particular time. However as the detector array is scanned across the image other parts of the image line are imaged later. Hence a complete image can be reconstructed. By allowing parts of an image line to be imaged later the detector elements for missing parts of the image line can be spaced apart in the scan direction. This effectively allows use of a two dimensional array to simulate a long 1-D or 2-D array.

Conveniently the two dimensional array of detector elements is formed into rows and columns and successive detector elements in a row are displaced from each other in a direction perpendicular to the scan direction.

As used herein the term row is means a line of detector elements which has the smallest angle to the scan direction. Two dimensional arrays having rows and columns are easy to fabricate. By displacing successive detector elements in a row from each other in a direction perpendicular to the scan direction the row is effectively set an angle to the scan direction. This can ensure that each successive detector element will see a different part of the image line and by the choice of angle of inclination the properties of the synthesised array can be controlled.

The rows and columns of the detector array may be perpendicular allowing a standard square or rectangular detector array to be used. The rows are set at an angle to the scan direction it can be seen that the detector array has effectively been rotated with respect to the standard situation wherein a rectangular array is used with the columns perpendicular to the scan direction.

Alternatively the columns could be at an angle to the perpendicular to the rows to form a stepped array. In which case the columns could conveniently be set perpendicular to the scan direction.

In another embodiment the apparatus could be adapted to translate the scene relative to the array in a first direction so as to image a different part of the scene. As the input mask has waveguides with relatively small inputs only part of the scene can be imaged at one time. Translating the scene relative to the image can allow a different part of the scene to be imaged. Preferable the scene is translated by an amount which is greater than the diameter of the waveguide input so as to ensure there is no overlap.

Conveniently the scene is translated in a first direction and a second substantially orthogonal direction in sequence so as to simulate a higher resolution array.

The apparatus may comprise a thermal imaging array. In which case the apparatus may comprise a cold stop located at the entrance pupil of the optical system. As the optical system guides radiation to the detector elements the cold stop of the device can be placed at the entrance pupil of the relay optical. This provides for very effective cold shielding as only radiation entering through the entrance pupil is imaged onto the detector.

The apparatus may be incorporated in an imaging system having a further input optical arrangement, the optical arrangement being arranged to transmit radiation from the focal plane of the input optical arrangement to the detector array.

According to a second aspect of the invention, a conversion plate for guiding radiation incident on one face thereof on to an array of elements comprises an array of waveguides or light-pipes.

The invention will now be described, by way of example only, with reference to the following figures in which;

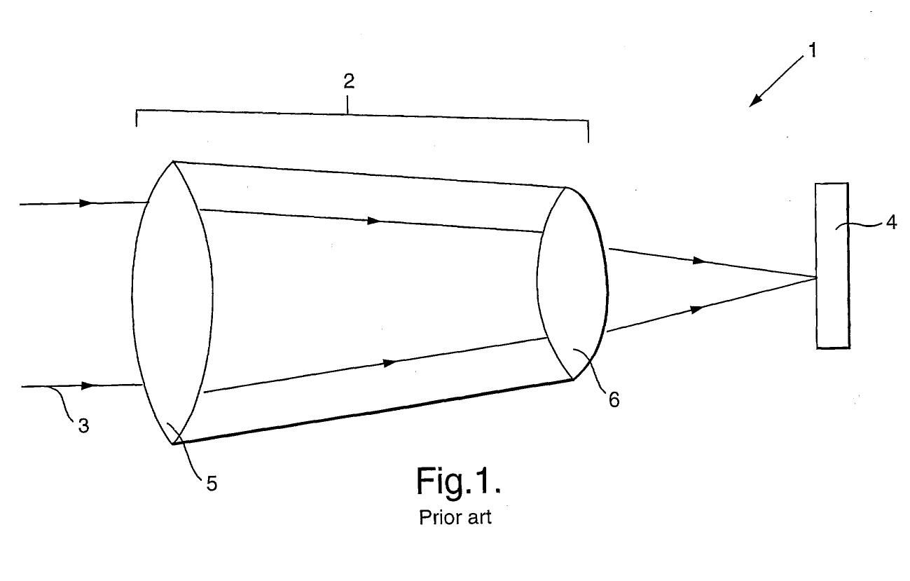

FIG. 1 shows a schematic diagram to illustrate the input optics of a conventional imager,

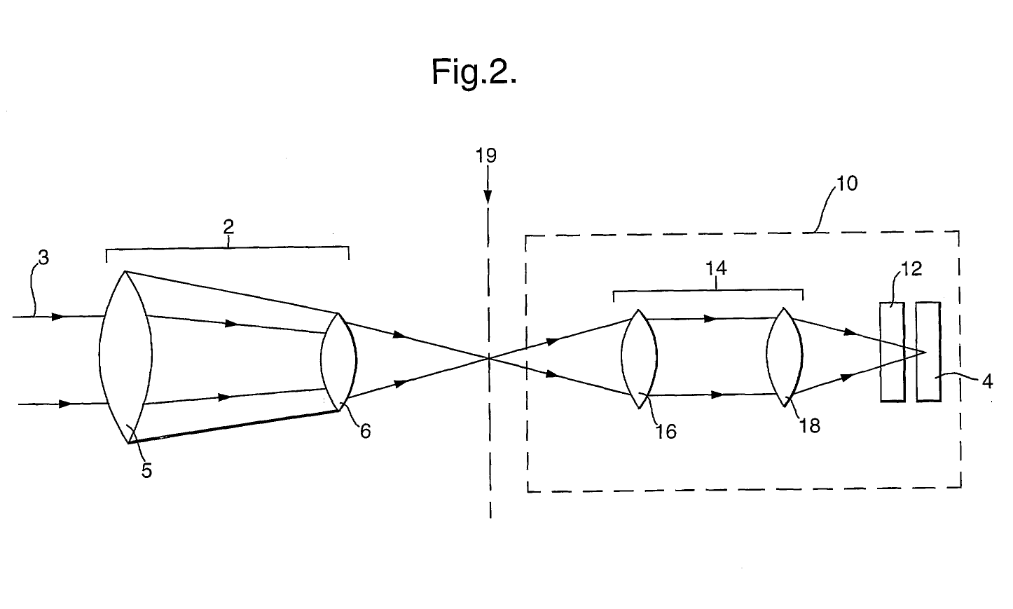

FIG. 2 shows a schematic diagram of the optical mapping apparatus of the present invention, included in a conventional imager,

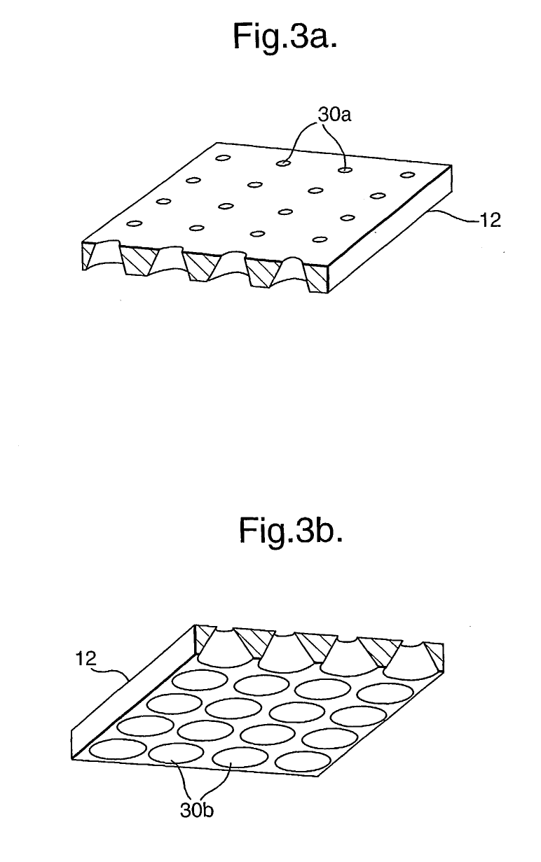

FIG. 3 shows (a) top and (b) bottom views of the conversion plate which may be used in the optical mapping apparatus of the present invention,

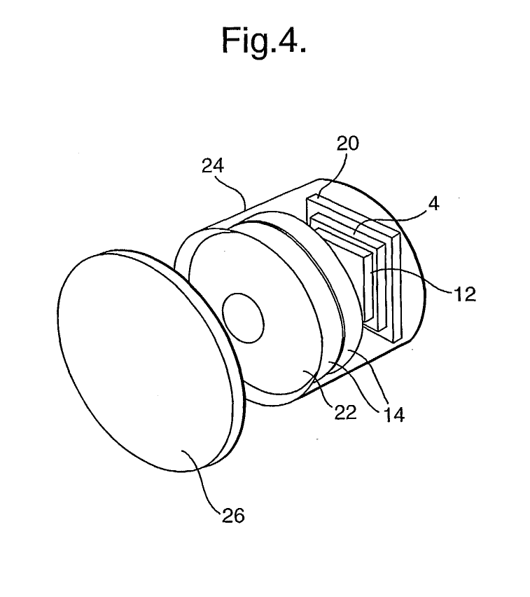

FIG. 4 shows a three dimensional view of the optical mapping apparatus of the present invention to illustrate construction,

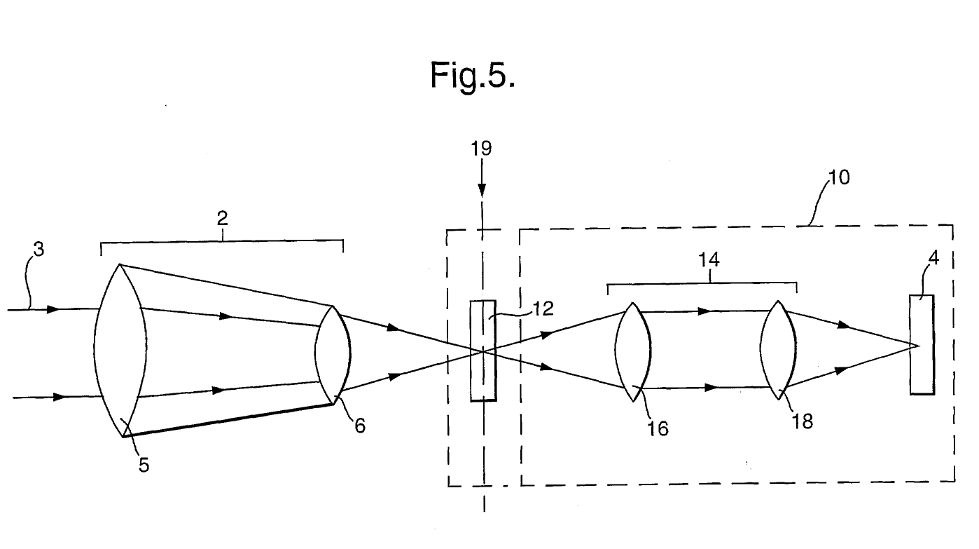

FIG. 5 shows an embodiment of the invention in which the conversion plate is mounted at an intermediate plane,

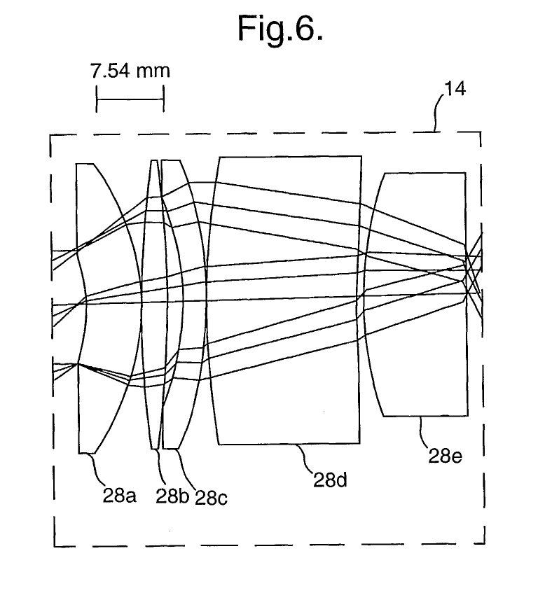

FIG. 6 shows a schematic diagram of an optical arrangement which may be used in the apparatus shown in FIGS. 2 and 3,

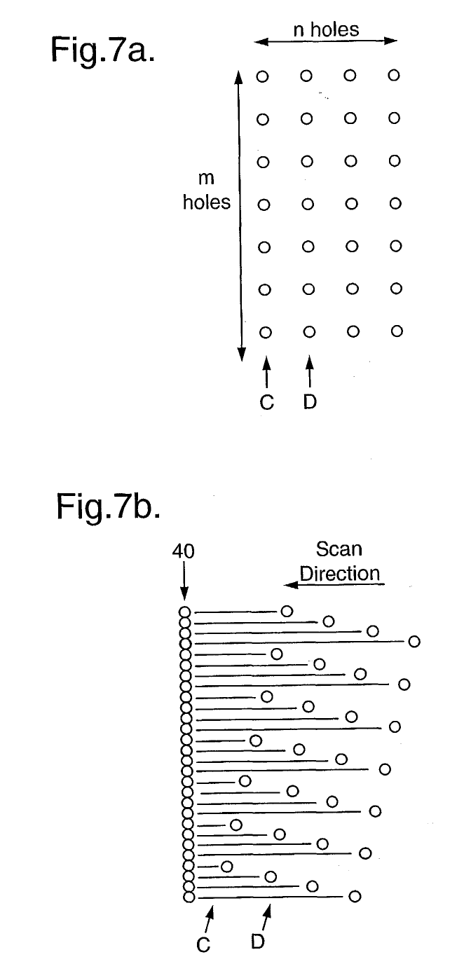

FIG. 7 shows the input face of the conversion plate (a) when perpendicular to the optic axis and (b) when rotated,

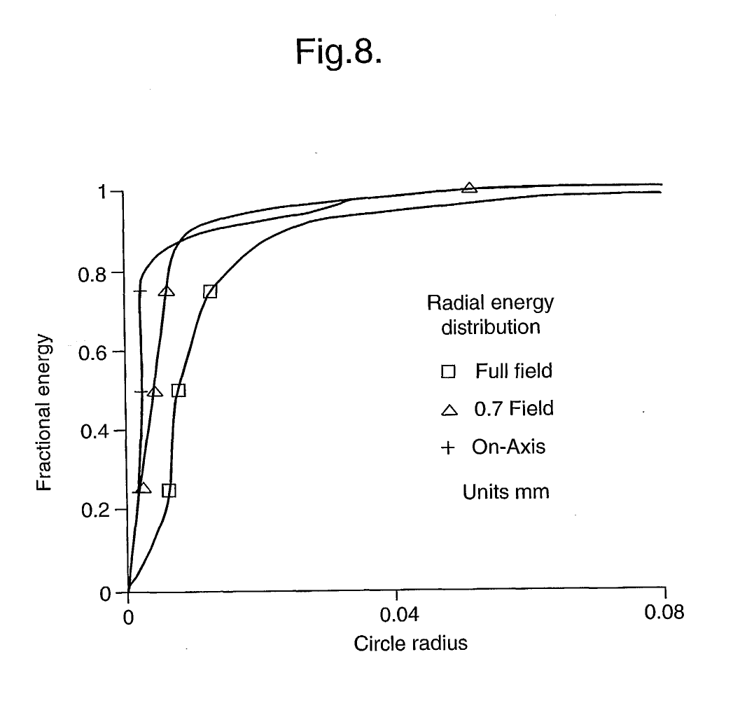

FIG. 8 shows the optical efficiency of the optical mapping apparatus,

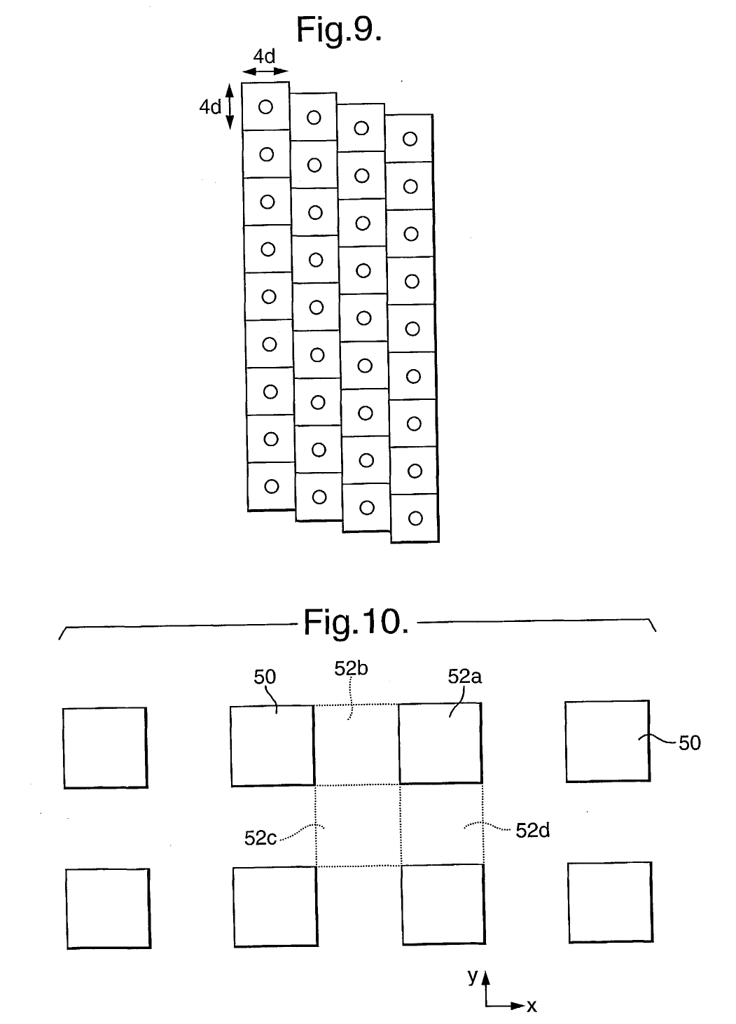

FIG. 9 shows a schematic diagram of a long linear detector array which may be used with the present invention.

FIG. 10 shows a schematic diagram of a scan pattern according to a different aspect of the invention.

The invention is described with reference to detection of infrared wavelengths but the invention is not intended to be limited to operation in this waveband.

Referring to FIG. 1, a conventional imaging apparatus 1 comprises an optical arrangement 2, through which input radiation 3 is transmitted. Radiation 3 is focused at detector array 4. In this example, the optical arrangement comprises two lenses 5, 6, but alternative arrangements comprising additional focusing elements could be employed.

Referring to FIG. 2, the present invention relates to an optical mapping apparatus 10 which may be used in a conventional imaging apparatus such as that shown in FIG. 1. The optical mapping apparatus comprises three main components; a detector array 4, a conversion plate 12 and an optical arrangement 14. The optical arrangement 14 illustrated comprises two lenses 16, 18 but alternative arrangements may be employed. Typically, the detector array 4 would be a two dimensional detector array, such as a commercially available 256×256 array. The conversion plate comprises an array of waveguides, or light-pipes, (not shown in FIG. 1) that guide radiation incident on the plate 12 onto an array of elements such as the detectors in array 4. For the purpose of this specification, the waveguides shall also be referred to as, and taken to include, tapered apertures.

The optical arrangement 14 takes as its input the image plane 19 of the input optical arrangement 2. This image is relayed onto the input face of the conversion plate 12. In this way it is possible to synthesise a long linear array, by making use of a commercially available two dimensional array of smaller dimension, as will be described later. For the purpose of this specification, the “input face” of the conversion plate 12 shall be taken to mean the face of the plate 12 which receives radiation from the optical arrangement 14 of the mapping apparatus 10 and the “output face” of the conversion plate 12 shall be taken to mean the face of the plate which is closest to the detector array 4.

The role of the optical arrangement 14 is twofold. Firstly, it concentrates input radiation from the input optics 2 onto the holes on the input face of the conversion plate 12 so that the energy reaching the detector array 4 is equivalent to that reaching the detector array 4 without the conversion plate 12. Secondly, the optical arrangement 14 compresses the long linear array format required onto the dimensions of the detector focal plane. For some applications the input optics 2 may not be needed, the optical arrangement 14 can be used to collect radiation from the scene and focus it onto the detector array 4.

FIGS. 3(a) an 3(b) show the top input view and the bottom output view respectively of the conversion plate 12 comprising an array of waveguides 30, or tapered holes, that guide radiation incident on the plate 12 onto the focal plane detector array 4. FIGS. 3(a) and 3(b) illustrate how the holes are tapered between a smaller input size (FIG. 3(a)) and a larger output size (FIG. 3(b)). Typically the output face will have holes 30b the same size as the detector pixels on the detector array 4, whilst typically the input holes 30a will be the size of the output hole 30b divided by the compression ratio required. The holes 30a, 30b are shown in FIG. 3 to be round but other shapes may also be employed e.g. square holes. The fabrication of the conversion plate will be described later.

FIG. 4 shows a three-dimensional view of the optical mapping apparatus 10 to illustrate how the apparatus may be assembled. The apparatus 10 also comprises a cold shield 22 within which the optical arrangement 14 is mounted. The apparatus 10 is mounted within a dewar 24 having a dewar window 26 to maintain a suitably low temperature. In this arrangement, the conversion plate 12 is in close proximity to the detector array 4, having a detector substrate area 20, with the optical arrangement 14 immediately in front of the conversion plate 12.

The conversion plate 12 may be mounted directly over the two dimensional detector array 4 and positioned so that the output holes 30b overlap single pixels (detector elements) of the array, as illustrated in FIG. 4. Alternatively, the conversion plate may be located at an intermediate plane and relay optics may be used to couple it to the detector. This arrangement of the apparatus is shown in FIG. 5.

FIG. 6 shows a schematic diagram of an optical arrangement 14 which may be used in the optical mapping apparatus 10 of the present invention. An arrangement having this construction has been designed. The arrangement comprises five elements 28a-28e all having spherical surfaces. Typically, the elements 28a-28e may be germanium elements. Other designs with different materials and number of elements could be used, for example an arrangement having fewer elements and having a spherical surfaces may also be used. The separation of lens elements 28a and 28b is shown to give an indication of the scale of the arrangement.

The preferred size of the holes 30a, 30b in the conversion plate 12 is determined by the detector array pixel size. An array of m×n holes, preferably of circular cross-section, are arranged on a rectangular grid with the centre of the holes spaced apart by an amount, d, in each of two dimensions, where d is the pixel pitch of the two dimensional detector array. The size of m is typically the number of pixels in a column of the two dimensional detector array 4, for example 256. The value of n represents the required compression i.e. n is the ratio of the desired length of the linear array to the number of pixels, m, in a column of the two dimensional detector array. If the required number of pixels is 1024 and m is 256, n is equal to 1024 divided by 256 i.e. n=4. The size of each hole, φ, at the input face of the conversion plate is given by;

φ=D/n

Where D is the pixel size of the detector array 4.

Therefore if D is equal to 30 μm and n=4, as in this example, the input hole size is 7.5 μm. The holes are tapered through the thickness of the conversion plate 12 so that at the output side (i.e. the side closest to the detector array 4) the hole size is substantially the same as the pixel size of the detector, D.

The optical arrangement 14 concentrates the image from the image plane 19 of the optical arrangement 2 by a factor it. This ensures that as much energy falls on each input hole of the conversion plate 12 as would have fallen on each pixel of the two dimensional detector array 4 if the conversion plate were not used. Other concentration factors could be used to produce more or less energy at the input holes depending upon system requirements. The optical arrangement also has the effect of shrinking the long, linear focal plane of length, L (where L=m×n×d), to the dimensions of the two dimensional detector array.

FIG. 7(a) shows the input face of the conversion plate 12 as it would be positioned squarely on top of the detector array 4 so that the holes in the conversion plate align substantially with the centre of each pixel of the detector array. FIG. 7(b) shows the configuration after the conversion plate 12 and the detector array 4 have been rotated by an appropriate angle. To achieve the required synthesis of a long linear array 40, the detector array 4 and conversion plate 12 have to be rotated together at an angle of tan⁻¹ (1/n). For the design under consideration above (n=4) this gives a rotation angle of 14°. The effect of this rotation is such that when the arrangement is scanned in a direction as indicated in FIG. 7, the bottom of the holes of the conversion plate (at the input side) in the first column (C) are aligned with the tops of the corresponding holes in the second column (D) similarly for D/E and E/F (third and fourth rows of holes called E and F). In this way, there is no oversampling when scanning, but also there is no dead space. Simply rotating the detector array without the conversion plate would result in overlapping pixels in the scan direction and a loss of spatial resolution compared to when the conversion plate is used.

FIG. 7(b) shows the equivalent long linear array 40 achieved by the combination of rotation of the plate 12 and the detector array 4 and scanning. This technique is referred to as “time delay” because each column is delayed behind the previous column in the scan direction. This time delay will have to be taken into account when reconstructing an image from the detector outputs.

Therefore, for the example described above, mapping a 1024 element array onto a 256×256 array with detectors on a 30 μm pitch and 30 μm pixel size requires a conversion plate comprising an array of 256×4 holes, on a 30 μm pitch. The holes were required to be 7.5 μm at the input face, tapering to 30 μm at the output face. The linear image plane, of length 256×4×30 μm (i.e. 30720 μm) needed to be concentrated by a factor of 4. Therefore, for detector optics of F/2.4, an optical arrangement of F/0.6 is required between the linear image plane and the conversion plate to concentrate the energy.

Optical mapping apparatus has been designed and manufactured using the optical arrangement 14 shown in FIG. 6 having a back focal length of 500 μm to accommodate the conversion plate 12. A shorter back focal length for the conversion plate 12 may be preferable, but such a lower thickness conversion plate may be more difficult to fabricate.

FIG. 8 shows the efficiency obtained using the optical arrangement shown in FIG. 6 and a conversion plate having input holes of 7.5 μm. The elements 28a-28b were germanium elements, as described above. The optics were F/0.6 and were designed to give a×4 compression when using F/2.4 input optics which are typically used in infrared imagers.

If the conversion plate were constructed with holes for each of the pixels in the detector −256×256 in our example—and similarly rotated and scanned, the result would be a synthetic rectangular array of aspect ration 256n×256/n. In our example an array of 1024×64 would be formed. Thereby synthesising a rectangular format 2D array.

In addition to the problems of fabricating long, linear infrared detector arrays with several thousand elements, there also exists the problem of cooling and efficiently cold-shielding such arrays. The present invention reduces this problem. The optical arrangement 14 shown in FIG. 6 enables the entrance pupil of the apparatus to be positioned at the cold-stop (i.e. 22 in FIG. 4), thereby providing efficient cold-shielding. Furthermore, as the F number is very low at the detector array, this enables very efficient collection to be achieved. Such an arrangement could be used in conjunction with the optical arrangement 14 shown in FIG. 6 without the conversion plate. The use of the optical arrangement provides the advantage that the collection efficiency is maintained and efficient cold shielding achieved.

The optical mapping apparatus of the present invention enables synthesis of very long detector arrays using large 2D arrays which are commercially available. In an alternative embodiment, it is possible to use the optical mapping apparatus of the present invention with staggered long linear arrays. In particular, this could be a commercially available 256×4 array of 40 μm detectors on a staggered 60 μm pitch to produce a 1024 long array without oversampling.

Alternatively, detector arrays could be developed, which have the geometry shown in FIG. 9. Using this approach detector elements 40 of diameter d may be configured in four columns on a pitch of 4d in each dimension. Each column is staggered by d along its length with respect to the neighbouring columns. This produces a geometry equivalent to that achieved with the conversion plate coupled to the 2D detector array, as described above. This configuration has the benefit of retaining the relatively short physical length of the detector in the dewar while maintaining a large detector pitch, thereby giving plenty of room for readout circuitry at each pixel for readout circuitry.

In another embodiment of the invention instead of a long constant scan the image is displaced relative to the array in a first direction and then in a second direction to build up a two dimensional image. In this way a two dimensional array can be used to simulate a two dimensional array with a greater resolution.

For instance a 256×256 array can be displaced in x and y directions to simulate a 512×512 array. The apparatus used may be the same as shown in FIG. 2 and the conversion plate may be the same as shown in FIG. 3. However instead of scanning the scene relative to the array as in the first embodiment the scene is displaced in a two dimensional pattern.

FIG. 10 illustrates an array of input holes 50 in a conversion plate suitable for use with the apparatus of FIG. 2. The input holes 50 are shown as being square but could be any shape. In a first scanning period any input hole in the conversion plate passes radiation to the detector from one particular part of the scene as shown by 52a. In the next scanning period the scene is displaced in the x direction. The detector array is effectively imaging part of the scene which was previously located at 52b, i.e. between the waveguide inputs. In the next period the scene is then displaced in the y direction to image the part of the scene originally located at 52c. In the next period the scene is displaced back in the x direction to image area 52d before finally the y displacement is removed and the detector array again images the scene at 52a. In this way the entire scene may be imaged by the 256×256 detector at a resolution of 512×512.

The size of the inputs of the conversion plate may be determined by the amount of imaging steps in any one direction. In the example given there are two steps in each direction and so the conversion plate input holes are preferably half the pitch of the detector elements.

Means for displacing the scene relative to the array (not shown) are well known to a person skilled in the art and include flapping mirrors or rotating polygons.

Fabrication of the Conversion Plate

The fabrication of the conversion plate will now be described in more detail. A conversion plate was fabricated from silicon, using etching techniques along the crystal planes in the material to fabricate the array of holes. Typically, silicon wafers are around 500 μm thick. For an array of holes having an input side diameter of about 7.5 μm and an output side diameter of about 30 μm, it was found to be necessary to have a silicon layer of about 13 μm in thickness. However, to increase the robustness of the plate, a silicon wafer was produced comprising a 500 μm thick substrate on top of which was a 1 μm oxide layer followed by a 13 μm silicon layer. The array of holes were fabricated in the 13 μm silicon layer and the 500 μm thick layer gave robustness to the plate.

The processing steps used to fabricate the plate were as follows. Initially, the surface of the 13 μm layer was oxidised and a resist was optically patterned onto this oxide. The pattern was transferred to the oxide using an anisotropic dry etch. Following removal of the resist the patterned oxide was used as a mask for a proprietary etch of the 13 μm silicon layer. This etch was orientation selective and produced tapering holes down to the oxide layer separating the 13 μm silicon layer from the silicon substrate. A similar procedure was used to remove a rectangular portion of the 500 μm thick silicon layer down to the separating oxide layer immediately below the hole structure which had been formed. The separating oxide layer was then removed using a wet oxide etch and the plate was sawn from the wafer.

A structure of 256×16 holes was fabricated and 16 columns were formed to provide redundancy in the case of damaged detector elements, either in manufacture or in use. The redundant holes provide the ability to obtain enhanced performance using off-focal plane Time Delay and Integrate (TDI) which is a well known technique used in imaging systems (see The Infrared Electro-Optical System Handbook, J S Accetta, D J Shumaker Executive Editors, SPIE Press.

Depending on the material from which the conversion plate is fabricated, other techniques could be used to fabricate the holes e, for example, by means of laser drilling, ion beam or chemical etching, A range of substrate materials may be used, such as metals, plastics, ceramics and semiconductor materials.

1. An imaging apparatus comprising a two dimensional detector array of detector elements and an input mask having a waveguide associated with each detector element, each waveguide having an input for receiving radiation for a scene and an output for passing radiation to its associated detector element characterised in that the output of each waveguide is larger than the input and wherein the apparatus comprises means for scanning the scene relative to the array so as to allow synthesis of a different sized array.

2. An imaging apparatus as claimed in claim 1 wherein the waveguide outputs are adapted such that substantially all the detector element receives radiation from the scene.

3. An imaging apparatus as claimed in claim 1 or claim 2 wherein the input mask comprises a plate and each waveguide comprises a tapered waveguide therethrough.

4. An imaging apparatus as claimed in any previous claim wherein the apparatus further comprises a first optical system for passing radiation from the scene to the input mask.

5. An imaging apparatus as claimed in claim 4 wherein the first optical system is adapted to increase the energy density of radiation at the input mask.

6. An imaging apparatus as claimed in claim 4 wherein the first optical system comprise means for focussing input radiation substantially onto the inputs of the waveguides.

7. An imaging apparatus according to any preceding claim wherein the input mask is located adjacent the detector array.

8. An imaging system as claimed in any of claims 1-7 wherein the apparatus comprises relay optical system disposed between the input mask and the detector array for passing radiation to the array.

9. An imaging system as claimed in claim 8 wherein the relay optical system increase the energy density of radiation on the detector array.

10. An imaging apparatus as claimed in any previous claim wherein the apparatus is scanned relative to a scene in a scan direction and wherein the input mask and detector elements are arranged such that radiation from different parts of an image line perpendicular to the scan direction is imaged at different times as the apparatus is scanned in the scan, direction.

11. An imaging apparatus as claimed in claim 10 wherein the two dimensional array of detector elements is formed into rows and columns and successive detector elements in a row are displaced from each other in a direction perpendicular to the scan direction.

12. A scanning apparatus as claimed in claim 11 wherein the optical arrangement comprises a means for ensuring that parts of an image line imaged by successive detector elements in a row are not substantially overlapping.

13. An imaging apparatus as claimed in claim 11 or claim 12 wherein the rows and columns of the two dimensional detector array are perpendicular to each other.

14. An imaging apparatus as claimed in claim 11 or claim 12 wherein the rows of the two dimensional detector array are set at an angle to the perpendicular to the columns.

15. An imaging apparatus as claimed in claim 14 wherein the columns are arranged to be perpendicular to the scan direction.

16. An imaging apparatus as claimed in any of claims 1-9 wherein the apparatus is arranged to translate the scene relative to the array in a first direction so as to image a different part of the scene.

17. An imaging apparatus as claimed in claim 16 wherein the scene is translated relative to the array by an amount greater than the diameter of the waveguide input.

18. An imaging apparatus as claimed in claim 16 or claim 17 wherein the scene is translated relative to the array in a first direction and a second substantially orthogonal direction in sequence so as to synthesise a higher resolution array.

19. An imaging apparatus according to any preceding claim wherein the detector array comprises a thermal imaging detector array.

20. An imaging apparatus as claimed in claim 4 or claim 8 wherein the optical arrangement locates the entrance pupil at a cold stop of the apparatus.

21. An imaging apparatus as claimed in any preceding claim further comprising an input optical arrangement, the input optical arrangement being arranged to transmit radiation from the focal plane of the input optical arrangement to the detector array.

22. A conversion plate for guiding radiation incident on one face thereof on to an array of elements comprising an array of waveguides or light-pipes.
